(19) United States
(12) Patent Application Publication
(10) Pub. No.: US 2008/0275729 A1
(43) Pub. Date: Nov. 6, 2008

(54) SYSTEM AND METHOD FOR POPULATION HEALTH MANAGEMENT

(76) Inventors: Nina Mithi Taggart, Sugarloaf, PA (US); Mark M. Ungvarsky, Sugarloaf, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/099,938

(22) Filed: Apr. 9, 2008

Related U.S. Application Data
(60) Provisional application No. 60/910,676, filed on Apr. 9, 2007.

(51) Int. Cl. G06Q 50/00

(52) U.S. Cl. 705/2

(57) ABSTRACT

The present invention relates generally to a system and method for population health management, and more particularly, but not exclusively, to a system and method for population health management that analyzes and utilizes, in part, membership information from a healthcare insurer database to assess and address health management needs of its members.

### RELATED APPLICATIONS

The present application claims the benefit of priority of U.S. Provisional Application No. 60/910,676, filed Apr. 9, 2007, the entire contents of which application are incorporated herein by reference.

### FIELD OF THE INVENTION

The present invention relates generally to a system and method for population health management, and more particularly, but not exclusively, to a system and method for patient health management that identifies risks to patient health and feeds the risk information to modified workflow management software so that patient health can be managed using the modified workflow management software.

### BACKGROUND

Among the problems and concerns facing many societies today, the ability to efficiently administer and manage health-care ranks among the most widespread, especially in countries such as the United States which is presently experiencing an aging population that is expected to require greater medical intervention. Coupled with the increased demand for health care resources, increasing costs for health care services are currently placing significant demands on both private and governmental budgets. Thus, there is a need in the art of patient health management for systems and methods that more efficiently identify risk to patient health and provide for management of such patients.

### SUMMARY

In one of its aspects the present invention provides a system for managing the health care of a population. The system includes a predictive modeling module adapted to compute risk information of an individual. The predictive modeling module is adapted to format the risk information to comport with the format of a health insurance claim. The system also includes a workflow management module having an interface for receiving a health insurance claim. The workflow management module is disposed in communication with the predictive modeling module to receive from the predictive modeling module the risk information in a standard claim field of the health insurance claim to provide an analytic claim.

The predictive modeling module may be adapted to compute or provide one or more of: a disease level that indicates the risk of the individual contracting a specific disease; a population risk score containing a numerical risk score that indicates whether the individual can benefit from clinical intervention; a level of priority for the risk score; a disease flag that indicates the type of disease for which the individual is at risk; a likelihood of hospitalization score that indicates the probability that the individual will require hospitalization; and, a numerical risk score indicating probability of illness based on analysis of pharmacy data of the individual (i.e., pharmacy risk score). Each of the disease level, population risk score, disease flag, likelihood of hospitalization score, and pharmacy risk score may be provided to the work flow management module for inclusion in a standard claim field of the health insurance claim.

In another of its aspects, the present invention provides a system for managing the health care of a population including a workflow management module having an interface for receiving a note containing information about an individual. The system also includes a predictive modeling module adapted to create a summary report comprising risk information of the individual. The predictive modeling module is adapted to format the risk information to comport with a note format of the workflow management module. To transmit the risk information to the note of the workflow management module, the predictive modeling module is disposed in communication with the workflow management module. The risk information may include one or more of a population risk score, a likelihood of hospitalization risk score, a pharmacy risk score, each of which may be transmitted to the note of the workflow management module by the predictive modeling module.

The present invention also provides, in one of it aspects, a system for managing the health of a population comprising a predictive modeling module adapted to compute a risk level of an individual and adapted to generate a reminder when the risk level increases relative to a previously computed risk level. The system also includes a workflow management module disposed in communication with the predictive modeling module, where the workflow management module has an interface for receiving the reminder from the predictive modeling module.

In addition to systems, the present invention provides methods for managing the health of a population. In these aspects the present invention provides a method for managing the health care of a population, comprising providing a workflow management module comprising an interface for receiving a health insurance claim; computing risk information of an individual; formatting the risk information to comport with the format of the health insurance claim; and providing the formatted risk information to the workflow management module in a claim field of the health insurance claim. Computing the risk information may include one or more of computing a disease level, computing a population risk score, computing a level of priority for the risk score, computing a likelihood of hospitalization score, and computing a pharmacy risk score. In another of its aspects, the present invention provides a method comprising providing a workflow management module having an interface for receiving a note containing information about an individual; creating a summary report comprising risk information of the individual; formatting the risk information to comport with a note format of the workflow management module; and transmitting the risk information to the note of the workflow management module. Further, the present invention provides a method comprising providing a workflow management module having an interface for receiving a reminder; computing a risk level of an individual; generating a reminder when the risk level increases relative to a previously computed risk level; and providing the reminder to the workflow management module.

### BRIEF DESCRIPTION OF THE DRAWINGS

The foregoing summary and the following detailed description of the preferred embodiments of the present invention will be best understood when read in conjunction with the appended drawings, in which:

FIG. 1 schematically illustrates an exemplary configuration of the data and system architecture of the health management system of the present invention;

FIG. 2 schematically illustrates an exemplary configuration of an analytic claim in accordance with the present invention;

FIG. 3 schematically illustrates an exemplary configuration of a report note containing data from a member level summary report in accordance with the present invention; and

FIG. 4 schematically illustrates an exemplary configuration of a reminder in accordance with the present invention indicating risk score increase.

### DETAILED DESCRIPTION OF THE INVENTION

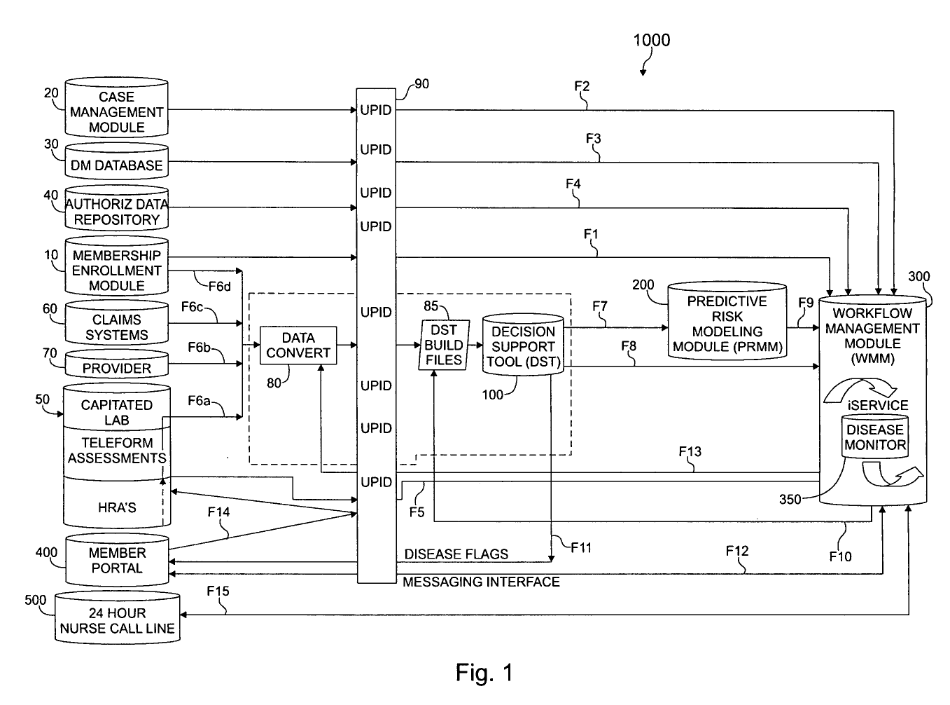

In response to the above-identified needs and with reference to FIG. 1, the present invention relates to a health management system 1000 and method for managing patient health that provides an automated clinical intelligence that identifies risks to patient health, informs a clinical case manager of such risks, and provides tools to the clinical case manager to permit clinical intervention to assist a patient identified to be at risk. In this regard, the system 1000 of the present invention may include a Decision Support Tool (DST) 100, a Predictive Risk Modeling Module (PRMM) 200, and a Workflow Management Module (WMM) 300 that cooperate to identify risk to a patient and permit workflow management of the health of such a patient by a clinical case manager. In addition, to enhance the quality of care by encouraging patient/member participation, a Member Portal 400 may be provided in communication with the Workflow Management Module 300 to allow the patient to provide personal data to the system 1000 and communicate with the clinical case manager.

The Decision Support Tool 100, Predictive Risk Modeling Module 200, Workflow Management Module 300, and Member Portal 400 may be provided in the form of commercially available products that are modified in accordance with the teachings of the present invention to provide new functionality, such as providing automated clinical intelligence that identifies risks to patient health. For example, the Decision Support Tool 100 may comprise a modified version of AdvantageSuite® software from MedStat Group, Ann Arbor, Mich.; the Predictive Modeling Module 200 may comprise a modified version of RiskSmart™ software from DxCG, Boston, Mass.; the Workflow Management Module 300 may comprise a modified version of the workflow management software, CareEnhance® Clinical Management System (CCMS®) of McKesson, Newton, Mass.; and, the Member Portal 400 may comprise a modified version of Health AtoZ software from Medical Network, Inc.

The Workflow Management Module 300 occupies a central location in the system 1000 in that the Workflow Management Module 300 receives several forms of data, including the identified risk data (scores) calculated by the Decision Support Tool 100 and Predictive Risk Modeling Module 200, and provides the software tools and interface that the clinical case manager may use to manage the health-care issues of the patient. Thus, in one of its aspects the Workflow Management Module 300 cooperates with the other system components to provide the automated clinical intelligence that identifies patient risk, an important contribution of the present invention.

However, since the Workflow Management Module 300 occupies such a central location, in another of its aspects, the Workflow Management Module 300 may conveniently provide functionality and a repository for data currently provided by stand-alone applications utilized in the health-care industry, enabling the clinical case manager to utilize a single interface to provide all desired patient case management functions. Since the system 1000 and method of the present invention may be utilized by the health-care industry in conjunction with already existing databases and modules, the present invention allows for integration with such existing databases and modules. For example, stand-alone modules such as a Membership enrollment Module 10, Case Management Module 20, Disease Management Database 30, and Authorization Data Repository 40 may communicate with and provide data to the Workflow Management Module 300 so the Workflow Management Module 300 may be utilized to access and act upon the data and functionality otherwise provided by these separate modules. In some instances, the data from such modules, e.g., the Case Management Module 20 and Disease Management Database 30, may be ported over to the Workflow Management Module 300 once to capture such data in the Workflow Management Module 300, and the Workflow Management Module 300 may take over the duties of such modules rendering them no longer necessary. Alternatively, certain modules, e.g., the Authorization Data Repository 40 and Membership Enrollment Module 10, may communicate and cooperate with the Workflow Management Module 300 (or other components of the system 1000) on an ongoing basis. Thus, the aspect of the Workflow Management Module 300 in which it provides functionality and a repository for data provided by stand-alone applications forms a convenient starting place for describing the layout and operation of the system 1000 in accordance with the present invention.

### Membership Enrollment Module to Workflow Management Module Eligibility Feed

Turning first then to the Membership Enrollment Module 10, the Membership Enrollment Module (MEM) 10 is an enrollment system that contains demographic and premium billing information on all constituent members, such as members of a health insurance provider. The Membership Enrollment Module 10 records eligibility information, including name, address, social security number, etc., to make record of a member in a health plan. Individuals are verified as valid members through the Membership Enrollment Module 10 which then allows claims to be processed or access to an application on their behalf. The membership data from the Membership Enrollment Module 10 may be loaded (feed F1) to the Workflow Management Module (WMM) 300 initially as a full membership feed of all members, after which changes may be loaded periodically, e.g., nightly, to the Workflow Management Module 300. The changes loaded into the Workflow Management Module 300 may include any type of membership change: additions, cancellations, changes to new primary care physician offices for HMO/POS members, changes to plan and product coverage, and demographic changes, including names, addresses, phone numbers, dates of birth, etc. The Workflow Management Module 300 may have a membership interface standard to a commercial embodiment (e.g., CCMS® of McKesson) of the WMM 300 that is used for this periodic feed (F1).

In addition to the standard membership feed (F1) that is sent periodically, several non-standard membership data points may be sent to the Workflow Management Module 300. These non-standard membership data points may include HIPAA privacy indicators, Medicare indicators, disability indicators, dual coverage indicators, pharmacy coverage indicators, a self/fully-insured indicator, TEFRA indicator, cancellation reasons and descriptions, and the use of a Universal Person ID (UPID), for example. The non-standard membership data points provide the clinical case manager with the required information without having to search several systems for the data, allowing the case manager to manage the person's clinical conditions more easily and accurately from a single interface. More specifically, the non-standard membership data points may include:
a.) HIPAA privacy indicators from the Membership Enrollment Module 10 to designate that the person has a HIPAA privacy address, a HIPAA responsible party, a HIPAA authorization allowing others to be contacted on their behalf, and/or a HIPAA personal representative;
b.) indicators from the Membership Enrollment Module 10 to identify if the person has Medicare coverage, along with the effective and termination dates of both Part A and Part B;
c.) indicators from the Membership Enrollment Module 10 to specify the type of disability coverage held, along with the effective and termination dates of coverage;
d.) an indicator derived from the Membership Enrollment Module 10 to signify that the person has more than one coverage in effect at the same time (dual coverage);
e.) an indicator from the Membership Enrollment Module 10 to identify that the person has pharmacy coverage;
f.) an indicator from the Membership Enrollment Module 10 to specify if the group coverage held by the member is through a fully-insured or self-insured arrangement to signify that the appropriate benefits may be in effect;
g.) an indicator from the Membership Enrollment Module 10 to identify the type of TEFRA code to which the employer group has attested (used in Coordination of Benefits designation); and
h.) dependent and subscriber-level cancel reasons from the Membership Enrollment Module 10.

As part of the present invention a unique Universal Person ID (UPID) may be created to assist the Workflow Management Module 300 in combining claims or medical data for members with multiple ID numbers. The UPID may be created with an algorithm that uses several data points to uniquely identify each member, regardless of their coverage time periods or their coverage types. Exemplary data points may include combinations of full and abridged first and last names, dates of birth, social security numbers (if available), gender, etc. Once a person has been assigned a UPID, that UPID number can forever be used to identify them as a unique individual within the health management system 1000. The UPID may be applied to all of the interface feeds to the Decision Support Tool 100, the Predictive Modeling Module 200, the Member Portal 400, and the Workflow Management Module 300, so that every covered member will have one UPID, regardless of the types or numbers of coverage held by that person. (The application of the UPID to the interface feeds is indicated schematically in FIG. 1 by the rectangular box 90 that intersects the feeds.) For instance, a member can have two coverages in force at one time: once as a subscriber on their own policy and once as a dependent on another's policy. Typically such a person would have two different ID numbers appearing on two separate ID cards and their claims utilization history would be split between the two separate ID numbers. Another example of a situation where a member could have multiple IDs includes a person who was enrolled years ago as a dependent under another's policy but, after a lapse in coverage, enrolled as a subscriber on their own policy. The UPID will uniquely identify this person as the same person and assign one UPID for use in the health management system 1000. The use of a UPID will allow members to be treated holistically within the health management system 1000.

### Case Management Module Feed

Another module whose functionality and data may be taken over by the Workflow Management Module 300 is the Case Management Module (CMM) 20, which is a system/database that is used by the clinical case manager to manage members in various catastrophic case management programs. The Case Management Module 20 may comprise, for example, the CaseTrakker© software of IMA Technologies, Sacramento, Calif. Examples of the catastrophic programs managed may include burns, transplants, AIDS, severe diabetes concerns, joint replacements, severe asthma concerns, oncology, high risk deliveries, etc. The data from the Case Management Module 20 may be loaded to the Workflow Management Module 300 in a one-time feed (F2). For instance, all cases in the Case Management Module 20 during a specified two-year time period with a status of “open” or “assessed” may be brought over to the Workflow Management Module 300. The Case Management Module 20 may continue to be used by the clinical case managers until this load is completed and verified in the Workflow Management Module 300. At that time, users of the health management system 1000 (e.g., clinical case managers) may begin to manage the members using the Workflow Management Module 300 instead of the Case Management Module 20. The Case Management Module 20 data may be available for viewing by the clinical case managers for a period of time after the conversion to the Workflow Management Module 300. However, management of the members may be performed using the Workflow Management Module 300 at the time that the conversion of data is complete.

### Disease Management Database Feed

The Disease Management (DM) Database 30, e.g., an Access database, may be used by clinical case managers to track and manage members in various Disease Management Programs. Examples of these Disease Management Programs include diabetes, asthma, coronary artery disease, smoking cessation, prenatal, and depression.

In addition, the cases brought over from the Disease Management Database 30 will play a role in the assignment of clinical case managers on new cases automatically opened in the Workflow Management Module 300 through the Decision Support Tool/Predictive Modeling Module process described below. The software for assigning a clinical case manager on a new case from the Predictive Modeling Module 200 may determine if there is already an open case from the Disease Management Database 30. If there is an open case from the Disease Management Database 30, a new case opened by the Predictive Modeling Module 200 may be assigned to the case manager identified on the Disease Management Database case. If there is not an open case in the Disease Management Database 30, the new case opened by the Predictive Modeling Module 200 may be assigned to a clinical case manager, and specifically to a disease management triage nurse team.

The data from the Disease Management Database 30 may be loaded to the Workflow Management Module 300 in a one-time feed (F3). Information for all members in the Disease Management Database 30 during a specified time period, e.g. 2 years, may be brought over to the Workflow Management Module 300. The Disease Management Database 30 may continue to be used by the clinical case managers until this load is completed and verified in the Workflow Management Module 300. At that time, the clinical case managers using the health management system 1000 may begin to manage the members using the Workflow Management Module 300, rather than the Disease Management Database 30.

The data being converted for use in the Workflow Management Module 300 may include many different data types. For example, five separate interface software programs may be provided for use with the Workflow Management Module 300. One interface will automatically open a case in the Workflow Management Module 300 for any of the Case Management Module cases in the time period optionally being converted. The other four interfaces bring over clinical assessment history from the Disease Management Database 30 to the Workflow Management Module 300. This information may be required by the clinical case managers in the on-going management of the members of the Case Management Module 20.

The data converted for use in the Workflow Management Module 300 may include many different data types. For three Disease Programs (smoking cessation, prenatal, and depression), the open cases in the Disease Management Database 30 will preferably open cases within the Workflow Management Module 300. In addition to opening cases based on the data for the Disease Management Programs in the Disease Management Database 30, the full clinical assessment history may also be converted to the Workflow Management Module 300, which may be required by the clinical case managers in the on-going management of these members. In addition, a reminder function present within the Workflow Management Module 300 may be used with this converted data, i.e., the open reminders in the Disease Management Database 30 may be brought over as open reminders in the Workflow Management Module 300, so that the clinical case managers can continue managing the patients without any delay or without having to create new reminders for on-going phone calls and interactions with the members.

For the diabetes, asthma, and coronary artery disease programs, the open cases in the Disease Management Database 30 preferably may not open cases within the Workflow Management Module 300. Members' cases for these three Disease Management Programs may be opened via the Decision Support Tool 100/Predictive Modeling Module 200 and the Workflow Management Module 300 interface and process flow described below. However, clinical assessment history may be converted from the Disease Management Database 30 to the Workflow Management Module 300, and the open reminders in the Disease Management Database 30 may be brought over as open reminders in the Workflow Management Module 300, so that the clinical case managers can continue managing the patients without any delay or without having to create new reminders for on-going phone calls and interactions with the members. Thus, interfaces are provided to open a case, transfer the clinical assessment data to assessments within the Workflow Management Module 300, and to bring over active reminders.

In addition, the cases and reminders brought over from the Disease Management Database 30 may play a role in the assignment of clinical case managers on new cases automatically opened in the Workflow Management Module 300 through the Decision Support Tool 100/Predictive Modeling Module 200 process described below. The software for assigning a clinical case manager on a new case opened the Predictive Modeling Module 200 can determine if there is already an open case/reminder from the Disease Management Database 30. If there is an open case/reminder from the Disease Management Database 30, the new case opened by the Predictive Modeling Module 200 may be assigned to the case manager identified on the Disease Management Database 30 case/reminder. If there is not an open case/reminder from the Disease Management Database 30, the new case opened by the Predictive Modeling Module 200 may be assigned to a disease management triage nurse team.

### Authorization Data Repository Feed

Another module which contains data that can be accessed directly by the Workflow Management Module 300 is the Authorization Data Repository 40. The Authorization Data Repository 40 contains admission notification and authorization information for all lines of business, excluding all behavioral health authorizations. The admission notifications include notifications for indemnity and for preferred provider organization (PPO) members from facilities that a member was admitted to their hospital. The authorizations are precertification approvals/denials performed by utilization management staff for all members for services that require such authorizations.

A daily feed (F4) may be made from Authorization Data Repository 40 to the Workflow Management Module 300 to load admission notifications and authorizations for a certain subset of services for the members. The subset of services that is pulled from the Authorization Data Repository 40 database may be selected, for example, by using ICD9 diagnosis and procedure codes, representing the types of services to be managed under Disease and Case Management Programs. The codes may include admission notifications and authorizations for conditions such as multiple sclerosis, diabetes, CHF, acute myocardial infarctions, aneurysms, renal failure, respiratory failure, Alzheimer's disease, deliveries, asthma, bypass surgeries, placement of stents, PTCAs, etc.

The daily feed from Authorization Data Repository 40 may include various pieces of data from the admission notifications and authorizations, including the beginning and ending service dates and/or admission and discharge dates, servicing provider information, all diagnoses and procedures found on the admission notification or authorization, and the clinical notes that were entered for the service by the utilization management staff.

The data fields and clinical notes from each admission notification or authorization may be entered into a “note” provided in the Workflow Management Module 300. The Workflow Management Module 300 maybe configured so that all of the Workflow Management Module notes have a specific note type and note reason, for easy identification and reporting. In addition, each admission notification and authorization may generate a reminder within the Workflow Management Module 300. The Workflow Management Module 300 may also be configured so that the reminders have a specific reminder type, reminder priority, and reminder subject, for easy identification and reporting. The reminders may be auto-generated to an existing clinical case manager (e.g., care management nurse or a care management triage nurse) if the member does not have an existing the Workflow Management Module case open. The clinical case manager may open a case for the member, as necessary, based on the information contained in the Workflow Management Module note, as well as the outcome of a triage assessment that is completed by the nurse. As used herein, “triage” refers to assessment of an individual member's case and application of clinical judgment to assess the member's needs to assign the case the most appropriate clinical resources.

The Workflow Management Module 300 may also include a separate module for the keying and handling of authorizations, which may be used independently of the Authorization Data Repository feed (F4).

### Wellness Database Feeds

Yet another module which may communicate directly with the Workflow Management Module 300, is a Wellness Database 50 may contain laboratory test results (labeled “capitated lab”), as well as enrollment and satisfaction survey responses (resulting in “assessments”, FIG. 1).

### Enrollment Survey Feed

A weekly feed (F5) may be performed from the Wellness Database 50 to the Workflow Management Module 300 to load various surveys, such as enrollment survey responses, from members. The enrollment surveys are mailed to members identified by the disease management algorithms or through referrals to the Population Health Management Program. The enrollment surveys may be specific to each disease, condition, or program. For example, for diabetes, asthma, CAD, COPD, and CHF, the survey results provide the clinical case managers with additional self-reported information from the members; and, for depression, prenatal, tobacco cessation, and weight management, the survey results may not only provide the clinical case managers with additional self-reported information from the members, but may also serve as ‘formal’ notification from the member that they want to enroll in the programs (i.e., these programs are ‘opt-in’ programs meaning that the member has to formally enroll). Though the questions on each enrollment survey may be specific to the disease being managed, there may be some questions that are used across surveys, such as height, weight, questions about tobacco use, questions about the members' confidence about managing their disease, questions about time missed from school/work, medication usage, etc. As new members are identified as having a disease or condition through an algorithm housed within the Decision Support Tool 100 (described below), or as new referrals are received by a clinical case manager, an enrollment survey is mailed to the member.

When the survey is returned, the form is scanned (e.g., using Teleform® software by Cardiff, Vista, Calif.) and is loaded into the Wellness Database 50. Survey versions and changes may be tracked using a mail date on the enrollment survey which may also be scanned into the Wellness Database 50. All versions of the enrollment forms may be mapped through an interface into the Workflow Management Module 300. For example, assessments are built in the Workflow Management Module 300 to mirror enrollment surveys. The feed (F5) from the Wellness Database 50 extracts and loads the responses into the appropriate assessment in the Workflow Management Module 300 so that the clinical case manager will have all of the member-reported information on a timely basis within the Workflow Management Module 300 for managing the member's medical condition. These assessments may then be used on an on-going basis by the case manager to update the member-reported data based on the on-going conversations with the member.

In addition, the reminder functionality within the Workflow Management Module 300 may be used to send a reminder to the clinical case manager when an enrollment survey is sent from the Wellness Database 50 to populate a Workflow Management Module assessment. As previously mentioned, reminders have a specific reminder type, reminder priority (using the SCF, above) and reminder subject, for easy identification and reporting. The reminders may be auto-generated to an existing clinical case manager if the member does not have an existing Workflow Management Module case open. The clinical case manager may open a case for the member, as necessary, based on the information contained in the Workflow Management Module Assessment loaded from the Wellness Database 50.

Further, within the Wellness Database 50, a Survey Clinical Factor (SCF) may be calculated for each survey returned. The SCF is a calculated score produced by an algorithm to use certain key responses from the enrollment survey to signify an initial “clinical level” for each member. The SCF is a high or low indicator that can be used by the clinical case manager to prioritize and categorize the new members on his/her daily workload.

Further, responses to key questions on the initial enrollment survey, as well as the on-going updates to those questions in the Workflow Management Module 300, may flow out of the Workflow Management Module 300 to the Decision Support Tool 100 (feed F10 described more fully below) (and the Predictive Modeling Module 200) on a monthly basis so the responses can be used as part of Return on Investment calculations and client reporting.

### Satisfaction Survey Feed

Unlike the feeds discussed so far which feed into the Workflow Management Module 300, a monthly feed (F6a) may also be performed from the Wellness Database 50 to the Decision Support Tool 100 to load satisfaction survey responses from members. Providing satisfaction survey responses to key questions on the satisfaction surveys into the Decision Support Tool 100 (and subsequently the Predictive Modeling Module 200) permits the satisfaction survey responses to be used as part of a Return on Investment calculation.

The satisfaction surveys may be mailed to members enrolled in the various Population Management Programs, either upon successful completion of the Population Management Program or annually, depending on the type of Population Management Program. The satisfaction surveys may be specific to each Population Management Program. The disease-specific satisfaction surveys may contain a combination of questions created by clinical staff and the Quality of Life satisfaction survey questions offered from QualityMetric Incorporated, Lincoln, R.I., for example.

### Capitated Lab Test Results and HRA Feed

Keeping with the feeds from the Wellness Database 50, but turning to the automated clinical intelligence aspect of the present invention, a monthly feed (F6a) may be performed from the Wellness Database 50 to the Decision Support Tool 100 to load specific lab test results and health risk assessment (HRA) (i.e., member self-reported) data, the latter being generated through the Member Portal 400 described below. (Cf. [0101] et seq.). Lab results that may be loaded to the Decision Support Tool 100 may include total cholesterol, HbAlc, HDL, LDL, potassium, triglycerides, microalbumin, and urine creatinine. The lab results may also be loaded from the Decision Support Tool 100 to the Predictive Modeling Module 200 and to a Clinical Variables table of Workflow Management Module 300. By loading the lab results to the Predictive Modeling Module 200, a combination of a risk score assigned by the Predictive Modeling Module 200 software (detailed below) along with combinations of lab result and may be used to identify other medium- or high-risk members to be managed through the Population Management Program. Loading the lab test results and HRA data to the WMM's Clinical Variables table allows the clinical case managers to better manage the members.

### Decision Support Tool Disease Management Participation Table

Turning now more fully to the clinical intelligence aspect of the present invention, the health management system 1000 includes a Decision Support Tool 100 that imports, stores, and organizes the eligibility, member demographics, provider/facility network information, medical and pharmacy claims history data, and self-reported data to act as a clinical data warehouse. The data in the Decision Support Tool 100 may typically comprise data extracted from Claims Systems 60 and eligibility data extracted from the Membership Enrollment Module 10; some of the data are straight moves from the source system, while other data may be produced through manipulations/conversions in the Decision Support Tool 100 to produce more meaningful, analytical pieces of information. For example, procedure codes, diagnosis codes, physician specialties, etc. may be grouped to provide easier analysis.

Claims may be fed into the Decision Support Tool 100 via feed F6c from a claims system 60, which is a system is used by health insurance companies and third party administrators (TPAs) to adjudicate medical and pharmacy claims, usually submitted by providers on behalf of their patients. Included in the adjudication of the medical or pharmacy claims is the verification of eligibility coverage, application of referral/precertification rules, application of benefit accumulators and limits, application of patient out-of-pocket financials, and application of provider pricing rules. Once the adjudication of the claim is complete and the various rules, policies and procedures of the health plan are applied to the claim, a payment is made to the provider or the patient to represent the final disposition of the claims adjudication process. Claims data are used throughout the HMS 1000 to classify and stratify patients and form the basis of client reporting.

Likewise, the membership demographics, provider/facility network information, may be fed into the Decision Support Tool 100 via feed F6b from a Provider file 70, which is an electronic representation of the provider network or provider directory of the health insurance company or TPA. The Provider file 70 provides demographic information for each provider, including items such as name, address, phone number, office hours, languages spoken, etc., and also includes indicators of whether that provider is participating with the particular health plan/product offering. The provider file 70 is used within the claims system 60 for claims adjudication purposes and is also helpful to customer service to identify which providers a patient can use based on their health plan/product requirements. The data from the Wellness Database 50, Membership Enrollment Module 10, Claims System 60, and Provider file 70 may be converted from their native source format by a data converter 80 to a form that is acceptable to the Decision Support Tool 100 and stored in a DST build files 85 ready for access by the Decision Support Tool 100.

In addition to acting as a repository for the data mentioned above, the Decision Support Tool 100 may contain a Disease Management (DM) Participation Table, which is a list of members with flags set to identify in which Population Management Programs a member is enrolled. The Participation Table may contain various data such as case open and close dates, indicating the dates a case is opened and closed; case open flags, indicating that a case is open; clinical levels indicators, indicating the relative severity of the condition as evaluated by the clinical case manager; Disease Flags, indicating presence of a medical condition; Disease Levels and Disease Level Indicators, indicating the relative severity of the patient as assigned in the PRMM; and DM durations, indicating the length of time that a patient has been participating in a population health management program. Further explanation of these terms is provided below in connection with discussion of the module by which they are created. For instance, some of the data may be created and stored as a result of the disease algorithms built within the Decision Support Tool 100, and some of the data may be created within the downstream Predictive Modeling Module 200 or the Workflow Management Module 300 and imported into the Decision Support Tool 100 via feeds F10 and F13.

Specifically, for example, the Disease Flags and DM durations may be created in the Decision Support Tool 100; the Disease Levels and Disease Level Indicators may be provided by the Predictive Modeling Module 200; the case open and close dates, case open flags, and clinical level indicators may be created in the Workflow Management Module 300. Customized interfaces for these data and logic are provided for the in-bound feed F8 to the Workflow Management Module 300 from the Decision Support Tool 100, the in-bound feed F7 to the Predictive Modeling Module 200 from the Decision Support Tool 100, and the in-bound feed F10 and F13 to the Decision Support Tool 100 from the Workflow Management Module 300.

### The Disease Flag

Considering first the Disease Flag, the Disease Flag is an important piece of information that flows through the various modules used in the health management system 1000. It becomes the trigger point for certain actions, such as identifying the clinical condition of the patient, within the Predictive Modeling Module 200 and the Workflow Management Module 300 as indicated below in connection with a discussion of those modules 200, 300. In addition, the Disease Flag becomes the center point for all reporting from the Decision Support Tool 100. Much of the automated functionality within the health management system 1000 derives from the Disease Flag. Disease flags may be set on the DM Participation Table to reflect Y (opt in), O (opt out), and blank (neither opt in nor opt out) in the following ways:
As members are identified through algorithms run periodically in the Decision Support Tool 100, the DM Participation Table may set the Disease Flags with an opt-in indicator to reflect that the member has a specific disease (i.e., diabetes, asthma, CAD, etc.). The algorithms may use diagnosis, procedure, and NDC codes to identify members with certain diseases.
As a case is manually opened in the Workflow Management Module 300 by a clinical case manager through a referral to a Disease Management or Population Management Program, the open case in the Workflow Management Module 300 is periodically exported (feed F10) to the Decision Support Tool 100 and thus to the DM Participation Table to set the corresponding Disease Flag with an opt-in indicator.
If a member has chosen to opt out of particular aspects of care management such as Disease or Population Management Programs, the opt-out function within the Workflow Management Module 300 is exported to the Decision Support Tool 100 via feed F10 and will signal the DM Participation Table to set the corresponding Disease Flag with an opt-out indicator.

Though much of the automated functionality within the health management system 1000 derives from the Disease Flag, additional actions are driven other by risk scores, such as a Disease Level risk score, Population Level risk score, Pharmacy risk score, and Likelihood of Hospitalization risk score as noted below. As used herein a risk score is a numeric value assigned to indicate the likely illness severity of a member. Risk scores can be backward looking (concurrent) or forward looking (prospective) based on the methodology in use. Risk scores are used throughout the invention to stratify members in order to place them in the appropriate intervention level of programs. For example, Disease Levels and Disease Level Indicators flow through the Workflow Management Module 300 to the DM Participation Table for analytical and ROI purposes (F10 and F13). The Disease Level is the numerical risk score assigned by risk models present in the Predictive Modeling Module 200; a H(high), M(medium), or L(Low) Disease Level Indicator is assigned based on the Predictive Modeling Module 200 numerical risk score. The Disease Level may be assigned in the PMM 200 based on a methodology imbedded within a commercial embodiment (e.g., RiskSmart™ software from DXCG) of the PMM 200 using an algorithm that evaluates diagnoses and demographics of the patient.

Continuing with the data contained in the DM Participation Table, the following data fields originate in the Workflow Management Module 300 and flow through to the DM Participation Table for analytical and ROI purposes: case open and close dates, case open flags, and Clinical Level Indicators (feeds F10 and F13). The case open and close dates track how long the member is being actively managed within the Disease Management or Population Management Program and are used to set a disease management duration field that allows for analytical reporting of the length of time each member is being actively managed within a Population Management Program. Clinical level indicators are indicators of H/M/L assigned by the clinical case manager, and used to help the clinical case manager prioritize/categorize the member from a clinical standpoint, and can be considered a ‘clinical case manager-override’ for the Disease Level Indicator calculated using the Predictive Modeling Module 200 risk score. The intervention counts also allow for ROI reporting in the Decision Support Tool 100, by tracking the number of member and provider interventions (phone calls, letters, faxes, etc.) made in the Workflow Management Module 300 for any particular member/disease/condition.

### Decision Support Tool to the Predictive Modeling Module Feed

Continuing now with the flow of information from the Decision Support Tool 100 to the Predictive Modeling Module 200, the Predictive Modeling Module 200 is a predictive modeling tool used to assign a risk score to each member using information from the Decision Support Tool 100. On a periodic basis, the Predictive Modeling Module 200 may be fed (feed F7) information from the Decision Support Tool 100. As part of the feed F7 (as well as feed F8 to the WMM 300 discussed below), specific data, such as membership, HRA, lab, claims, and providers/facilities, may be extracted using a script. The extracted information may include both PMM fields standard to a commercial embodiment (e.g., RiskSmart™ software from DxCG) of the PMM 200 and non-standard fields provided by the present invention for analysis. The non-standard fields may be used to refine the Predictive Modeling Module 200 derived risk score as well as to pass information unchanged to the Workflow Management Module 300. The commercial embodiment of the Predictive Modeling Module 200 has a standard interface already built to load the standard fields, whereas the present invention provides a customized interface for the non-standard fields.

In addition to the non-standard fields, data may be loaded to the Predictive Modeling Module 200 linked both to the current Person Number ID and to the UPID, which will identify each person uniquely regardless of the types, numbers, or sources of coverage held by the person. Fields linked to the Person Number ID may include primary care physician, product/plan, and employer group reporting using the Predictive Modeling Module 200; fields linked to the UPID may include risk setting at the person level, regardless of the member's coverage.

Fields standard to the interface of the commercial embodiment may include member demographics, eligibility begin and end dates, coverage type, and claims history data, including dates of service, procedure codes, diagnosis codes, places of service, providers, charge and payment amounts, and NDC codes. Non-standard fields provided by the custom interface may include: additional member demographics fields; Disease Flags to signify that the person has been identified as having a disease through the Decision Support Tool algorithms; case open flags that flow from the Workflow Management Module 300 to the Decision Support Tool 100 and then to the Predictive Modeling Module 200 to signify that the person has an open case in the WMM 300; Disease Level which signifies the Predictive Modeling Module numerical risk score and the H/M/L Disease Level Indicators; duration enrolled in the various disease programs; lab test results; and, member self-reported data, such as BMI, tobacco use, personal medical history, family medical history, income and education levels, and quality of life survey scores. Exemplary uses of non-standard fields include identifying members with lower risk based on claims history, but with complicating factors, such as tobacco use, high BMI, etc.

Once these fields are loaded in the Predictive Modeling Module 200 from the Decision Support Tool 100, several models may be run, e.g., based on the predictive modeling programming of RiskSmart™ software from DxCG. The outcomes of the models are different risk scores that depend on the type of model run. For instance, four different models may be run and fed (feed F9) into the Workflow Management Module 300: one that will produce prospective risk scores (predicted Year 2 scores, e.g., scores are correlated with the cost of the health burden carried by the patient); one that will produce concurrent risk scores (current Year 1 scores); one that will produce risk scores based solely on pharmacy claims data; and, one that will produce a Likelihood of Hospitalization risk score. Other customized models may be run in addition to these four, based on analytical needs.

Once the data from the four model runs are generated within the Predictive Modeling Module 200, the data are extracted for loading to the Workflow Management Module 300, optionally on a periodic basis (see the “Predictive Modeling Module to the Workflow Management Module Feed” section below).

In addition to the generation of the risk scores from running these four models, the Predictive Modeling Module 200 may be used within the health management system 1000 to identify other members who may require some amount of touch by the clinical case managers. For instance, a person may not be identified with a higher risk score based on their claims history, but one may want to target people for interventions based on a combination of their risk score and the non-standard fields. For instance, a member may have a high Disease Level (numerical risk score) but have no Disease Flags for the diseases (e.g., diabetes, asthma, coronary artery disease, congestive heart failure, etc.) being managed. However, based on responses to the Health Risk Assessment questionnaire loaded into the Wellness Database 50, the system may contain data that the member smokes, and/or has a large family history of various diseases, etc. The health management system 1000 may utilize combinations of data (e.g., smoking, missed days of work/school, family history, member history, race, education level, income level, lab results, industrial class code of the employer group, etc.) to try to identify people who should be managed by the clinical case managers beyond the chronic diseases for which Disease Flags are established.

For example, typical queries involve combinations of Disease Level scores with other factors like Health Risk Assessment responses, disease groupings, and biometric results such as high cholesterol levels. The clinical case managers may then determine whether those members should be managed, with cases opened in the Workflow Management Module 300, based on their triage assessment or upon initial contact with the member.

### Decision Support Tool to the Workflow Management Module Feed

Turning next to the direct interaction between the Decision Support Tool 100 and the Workflow Management Module 300, on a periodic basis, the WMM 300 may be fed (feed F8) information from the DST 100. This information may include both the Workflow Management Module fields standard to a commercial embodiment of the WMM 300 and non-standard fields. The commercial embodiment of Workflow Management Module 300 has a standard interface already built to load the standard fields and files; a customized interface for the non-standard fields for enabling automated clinical intelligence is provided by the present invention.

Standard files in the standard commercial interface may include fields for member demographics and coverage (for use with external members/clients); full loads of procedure codes, diagnosis codes, NDC codes, and DRG codes; products/plans, employer groups, full loads of provider and facility files, and claims history data. Non-standard fields in the custom interface may include additional member demographics fields and lab test results.

The Workflow Management Module 300 may include a Disease Monitor 350 which may be fed with standard claims history feeds needed to generate letters for exceptions created within the Disease Monitor 350. (The Disease Monitor 350 is a module offered by McKesson that allows one to define populations of interest, clinical rules, and exception reporting based on these rules.) Exception reporting will result in letters being sent to patients or other actions being suggested. For instance, one can define a diabetic population and define an eye exam, and set up a rule that will send a letter to a patient if there is no evidence in their claims history that they have had an eye exam in the last 12 months. As another example, one can define asthma and define a prescription for oral corticosteroids. One can then set up a rule to send a letter to a patient if there is no evidence in their claims history that they have received a refill on a prescription of an oral corticosteroid within x days of their prior prescription.

The member demographics and coverage and primary care physician history feed (F8) from the Decision Support Tool 100 to the Workflow Management Module 300 may be used for non-members of the heath care insurer. For instance, data for all of the health care insurer's members may be loaded using the Membership Enrollment Module 10 to the Workflow Management Module 300 feed (F1); the Decision Support Tool 100 to the Workflow Management Module 300 feed (F8) may be used only to load the non-members of the health care insurer on a monthly basis.

### Predictive Modeling Module to Workflow Management Module Feed

As previously mentioned, the Predictive Modeling Module 200 is a predictive modeling tool and is used to assign a risk score, e.g. Disease Level, Pharmacy, and/or Likelihood of Hospitalization risk score to each member. Claims history, member demographic/enrollment and Health Risk Assessment (HRA) data may be loaded (feed F7) to the Predictive Modeling Module 200 from the Decision Support Tool 100, using both the current Person Number ID and the new Universal Person ID, which will identify each person uniquely regardless of the types or numbers of coverage held by the person. Loading certain fields linked to the Person Number ID (e.g., primary care physician selection, product/plan and employer group information) will allow for primary care physician, product/plan, and employer group reporting using the Predictive Modeling Module 200; loading certain fields linked to the UPID (e.g., HRA responses—family history of certain diseases, income level, blood pressure readings, etc.—and lab results—total cholesterol level, triglycerides level, LDL level, etc.—) will allow for risk-setting at the person level, regardless of the member's coverage.

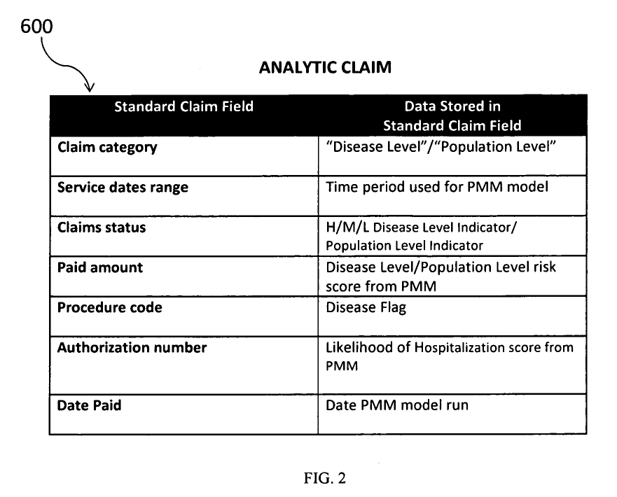

Once risk models described above are run with the Predictive Modeling Module 200 (Cf. [0054] et seq.), on a periodic basis, the PMM 200 may feed (F9) information to the Workflow Management Module 300 in four different ways to automate clinical intelligence within the process:
as an Analytic claim 600 that stores the Predictive Modeling Module 200 risk information, (as used herein an “Analytic Claim” is defined to be Predictive Modeling Module data (e.g., RiskSmart™ data) entered into the fields of a WMM claim (e.g., a CCMS® claim), (Cf. [0065] et seq., FIG. 2);
as a Note 700 to store the Predictive Modeling Module 200 member level summary report data (Cf. [0067] et seq.);
as a Reminder 800 to indicate when a disease-specific risk score increases from Medium to High from one month to the next—for example, if the Disease Level (numerical risk score) coming out of the PMM 200 increases from one month to the next for a patient, a Reminder 800 is sent to a clinical case manager to alert them to the fact that the member's risk score increased (Cf. [0068] et seq.); and
to automatically open cases for certain diseases based on the risk score calculated for the disease (Cf. [0069] et seq.).

Part of the interface between the Predictive Modeling Module 200 and the Workflow Management Module 300 is an INI table that will categorize the risk scores by disease into a high, medium, and low risk level, to aid in the prioritization and categorization of members for management. Risk scores and risk levels (H/M/L) may be generated, exported and loaded for disease-specific populations (i.e., diabetics, asthmatics, etc.) and for the population overall, i.e., the Population Level risk score and a H/M/L Population Level Indicator which may be assigned in a manner similar to that of the H/M/L Disease Level Indicator. The disease-specific scores and indicators are used to manage members within specific disease programs; the population-specific scores and indicators are used to identify other members who can benefit from some intervention by the clinical case managers.

### The Workflow Management Module Analytic Claim

The McKesson CCMS® software (one embodiment, as modified herein, of Workflow Management Module 300) routinely loads claims history within their claims module. The CCMS® software contains standard claims fields to reflect health insurance claims payments for a member. In one embodiment of the present invention, the data generated from the Predictive Modeling Module 200 is put into the claims module using the standard claims fields in a non-standard way (thus, the term “Analytic Claim”). A separate Analytic Claim may be generated for each of the Disease Level and Population Level risk scores, for example. Examples of these standard fields and the non-standard use for the Analytic claim 600 are outlined below (cf. FIG. 2):
a.) Claim category field—used to designate the type of risk information stored within the Analytic Claim. For instance, the text “Disease Level” or “Population Level” may be stored in the claim category field to indicate that disease or population risk information is stored in the Analytic Claim. Every member in the Predictive Modeling Module 200 will receive Population Level risk information regardless of their condition. Every person in the Predictive Modeling Module 200 with a Disease Flag from the Decision Support Tool 100 will also get Disease Level risk information which is used to stratify patients with specific conditions.
b.) Service dates range field—used to designate the 12-month period used for the PMM model that was run, using the Model Start Date and Model Run Dates fields from the PMM 200.
c.) Claims status field—used to designate the High, Medium, or Low level for the Disease Level or Population Level risk scores (i.e., Disease Level Indicator and Population Level Indicator, respectively) based on the entries in the INI table.
d.) Paid amount field—used to designate the Disease Level or Population Level risk score generated from the PMM model. The Population Level is the risk score assigned to a given member within the population as a whole irrespective of disease or condition specific subgroups. The Disease Level is the risk score assigned to a given patient indicating relative risk within a defined subgroup of the overall population.
e.) Procedure code field—used to designate the Disease Flag for the member (e.g., DIAB=diabetes, ASTH=asthma, POP=population level, CAD=Coronary Artery Disease, etc.) to segment the population by the Disease Flags/Population Management Programs and used to trigger further clinical automation, for example, population interventions through the Disease Monitor 350. Procedure codes are set based on the Disease Flag that originates in the Decision Support Tool 100 which are sent to the Predictive Modeling Module 200 and then to the Workflow Management Module 300. For example, a Disease Flag in the Decision Support Tool 100 for asthma would correlate to an ASTH procedure code in the Workflow Management Module 300.
f.) Authorization number field—used to designate the Likelihood of Hospitalization score generated from the PMM model. The Likelihood of Hospitalization score (also known as the probability of hospitalization score) is a numerical value that is produced from a model in the Predictive Modeling Module 200 which indicates the likelihood that a person will be hospitalized. It is a numerical value between 0 and 100% and is part of the Predictive Modeling Module 200.
g.) Date paid field—used to designate the date that the model was run in the Predictive Modeling Module 200, using the PMM field “Model Run Date”.

An Analytic claim 600 for each claim category (disease-specific vs. population-specific) may be loaded periodically. A separate Analytic claim 600 may be loaded for a member for each disease for which they have the Disease Flag; i.e., for January, a member would have three separate Analytic claims 600 loaded if the member is flagged with three diseases. Each of the three Analytic claims 600 would have a claim category field containing a Disease Level, but each Analytic claim 600 would have a different Disease Flag in the procedure code field to signify the type of disease. The Analytic claims 600 may also be used to export the data for each member for the Decision Support Tool interface F10 and F13.

### Member Level Summary Report “Note”

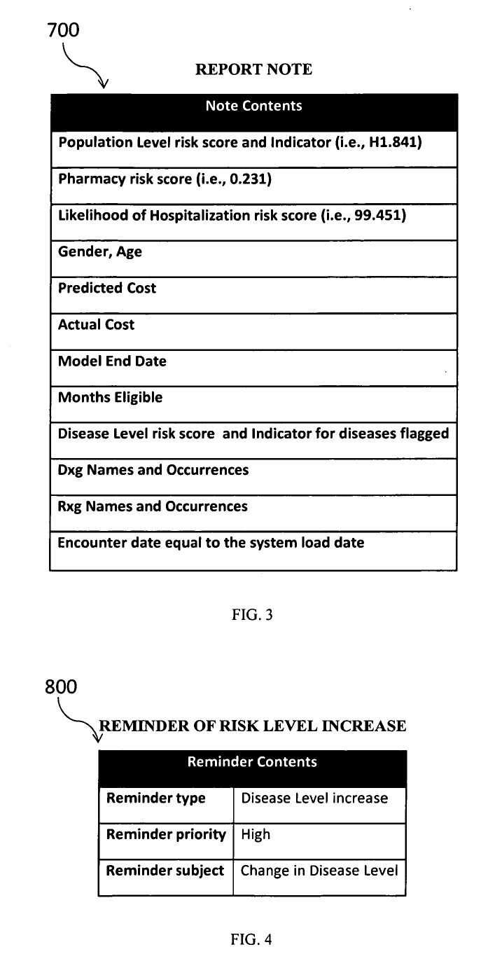

One of the outputs of the models that may be run in the Predictive Modeling Module 200 is a member level summary report. This report may be generated monthly for every member and the data from the report sent and stored within the Workflow Management Module 300 using a note functionality existing in the WMM 300, FIG. 3. The Workflow Management Module 300 may be configured so that the Note 700 will have a specific note type and note reason for easy identification and reporting. For example, the monthly Note 700 in the Workflow Management Module 300 may contain the following report information:
Population Level risk score and Indicator (i.e., H1.841);
Pharmacy risk score, numerical score indicating probability of illness based on analysis of the pharmacy data (i.e., 0.231);
Likelihood of Hospitalization risk score (i.e., 99.451);
Gender, Age;
Predicted Cost;
Actual Cost;
Model End Date;
Months Eligible;
Disease-specific Levels and Indicators for those diseases flagged for the member;
DxG Names and Occurrences;
RxG Names and Occurrences; and,
Encounter date equal to the system load date.
   The DxG names and occurrences are diagnostic groupings which will allow the clinical staff to see each member's comorbid conditions, and the RxG names and occurrences are pharmaceutical groupings which will allow the clinical staff to see the types of drugs the member has been taking during the 12-month model run period.

### Reminder for Increase in Risk Level

Periodically, e.g. monthly, as the new risk scores and levels come over from the Predictive Modeling Module 200 to the Workflow Management Module 300, a comparison of the Disease Level Indicator (High, Medium, or Low) may be performed to determine if any levels have increased from a Medium to a High. If the level for any disease has increased from a Medium to a High, once the new monthly data is loaded to the Workflow Management Module 300, a Reminder 800 of risk level increase may be sent to the clinical case manager to alert them to the fact that the member's risk level increased. The Reminder 800 of risk level increase will notify the clinical case manager in a timely manner, so that additional interventions etc. can begin with the member immediately. The Workflow Management Module 300 may be configured so that the Reminders 800 will have a specific reminder type, reminder priority that ranks the priority, and reminder subject for easy identification and reporting, e.g. reminder type=Disease Level increase, reminder priority=High, reminder subject=change in Disease Level, FIG. 4.

### Case Open Functionality

Periodically, e.g. monthly, as the new risk scores, levels, and Disease Flags come over from the Predictive Modeling Module 200 to the Workflow Management Module 300, a disease-specific case may be opened for a member if the disease-specific risk level is Medium or High, and the member does not already have a case open for that disease. The case open functionality automates the process of creating cases to begin the management of newly identified members, and automates the assignment of a new case to an existing clinical case manager or the triage area, so that the case can be assigned to a clinical case manager.

### Workflow Management Module to the Decision Support Tool Feed

The Workflow Management Module 300 and Disease Monitor 350 are the modules that serve as the day to day clinical workflow management modules, and are the modules in which the clinical case managers monitor and use to manage the members enrolled in the Disease and Case Management Programs. The Workflow Management Module 300 and Disease Monitor 350 may also used to generate reminder letters to members on services that they have not yet received (i.e., annual flu shots, HbAlc lab tests for diabetics, etc.). The management and interventions that a clinical case manager completes with a member are documented and tracked within the Workflow Management Module 300 and Disease Monitor 350 through the combination of interfaces.

On a periodic, e.g., monthly, basis the Workflow Management Module 300 exports and feeds (F10 and F13) information to the Decision Support Tool 100. The exported information may include both WMM fields standard to a commercial embodiment of the Workflow Management Module 300 and those non-standard fields described above that are needed for analysis purposes to flow back to the Decision Support Tool 100. Additional custom fields are provided in the Decision Support Tool 100 to house the information being exported from the Workflow Management Module 300. A principal purpose of flowing these data elements back to the Decision Support Tool 100 from the Workflow Management Module 300 is for Return on Investment (ROI) reporting and analysis, as well as employer group reporting, physician reporting, network analysis, program analysis, and refinement and health outcomes research, etc. These data points permit reporting on multiple levels of ROI, clinical outcomes and processes to clients.

The information exported out of the Workflow Management Module 300 and Disease Monitor 350 on a monthly basis includes various types of data. Some of this data originates in the Workflow Management Module 300/Disease Monitor 350, while other pieces of the data originate in the Predictive Modeling Module 200 and are passed to the Decision Support Tool 100 through the Workflow Management Module 300. The data points from the Workflow Management Module 300/Disease Monitor 350 and Predictive Modeling Module 200 may include:
specific assessment responses (via F10 and F13),
member self-reported lab test results (via F10 and F13),
counts of interventions (via F10 and F13),
information on members who have opted out of the various Population Management or Disease Management Programs (via F10 and F13),
information on members who have opted in to Population Management or Disease Management Programs (via F10 and F13),
case open flags along with case open and close dates (via F10 and F13),
clinical levels assigned by the clinical case manager (via F10 and F13), and
PMM Disease Level risk scores, Population Level risk scores, Pharmacy risk scores, Likelihood of Hospitalization risk scores, and model end dates and model run dates (via feed F10 and F13).

Assessments are provided in the Workflow Management Module 300 for each of the Disease Management and Population Management Programs. The assessments are the ‘scripts’ that are used by the clinical case managers while they are working with and managing the individual members' disease conditions. Assessments are similar to Health Risk Assessments, in that assessments are a series of questions specific to a disease that serve to gather detailed information from the patient so that the clinical case manager can determine what type of intervention the patient needs. Assessments include biometric data (cholesterol levels, blood pressure readings, height/weight/body mass index), information on person's caregivers and household conditions, medications currently being used by the person. Each disease can have it's own set of assessment questions depending on the type of information that is critical for each disease.

Each assessment contains information that is deemed necessary for the clinical case manager to know from the member in order to better manage the member. Some of these assessment questions and responses may become critical for ROI reporting back to the clients, so certain responses are extracted from the Workflow Management Module 300 to feed back to the Decision Support Tool 100. Some of the assessment questions and responses include member self-reported lab test results, such as the HbAlc, LDL, HDL, total cholesterol tests, as well as items like BMI, blood pressure readings, readiness to change, tobacco use, etc.

As clinical case managers work with the members and document the various types of interventions done with the members, those interventions will flow to the Decision Support Tool 100 to record the counts of interventions for the various Disease Management and Population Management Programs. These counts of interventions may become a piece of ROI reporting to clients, since a greater number of counts indicates a greater investment.

As members choose to opt-out of a Disease Management or Population Management Program, the information on the opt-out is recorded in the Workflow Management Module 300 and Disease Monitor 350 and flows back to the Decision Support Tool 100. The purpose of recording this information in the Decision Support Tool 100 is two-fold: for ROI reporting and analysis for clients, and so that the Decision Support Tool 100 does not re-identify the member as having the disease in the future through the running of the disease algorithms. This feature helps to protect privacy and security for members. Likewise, if a member opts into a Disease Management or Population Management Program outside of the algorithm and the Predictive Modeling Module 200 Disease Level process, the information will flow back to the Decision Support Tool 100 for ROI and program improvement purposes.

### Member Portal Feeds

Member Portal 400 is an on-line portal that may be used by covered individuals (members) to complete a Health Risk Assessment (that is loaded to the Wellness Database 50 via feed F14), complete a personal health record, enroll in on-line health coaching programs, learn more about their chronic diseases, and communicate via email to health coaches and care coordinators. Covered individuals may access the Member Portal 400 after requesting a personal identification number (PIN). Once the PIN is provided, the individual can access the Member Portal 400 using a single sign-on process, in conjunction with the Member Portal 400. The single sign-on process validates the individual's participation against the Membership Enrollment Module 10 and its corresponding non-member database. Once the single sign-on process verifies that the individual is able to access the Member Portal 400, the individual can access all of the information contained on the Member Portal 400.

The Member Portal 400 may contain a full complement of educational information on various diseases and offers interactive tools that can help individuals better monitor their disease states. Some of the items that may be included are:
a. Health Risk Assessment (HRA)—a questionnaire filled out by the member to assess their overall health status; includes questions on medical conditions and family history; specific biometric results, including height, weight and blood pressure and cholesterol readings; use of tobacco, alcohol and drugs; seat belt usage; speed limit adherence; stress levels; dietary habits; quality of life indicators; frequency of preventive screenings; etc. The assessment provides an overall score for the individual, identifies items where the individual scored high and low, and provides a development plan to help the individual improve those items where they scored low.
b. Personal Health Record (PHR)—a series of items the individual can complete so they can have a complete on-line record of their current and previous medical conditions, prescription and over-the-counter medications, previous and upcoming doctor appointments and surgeries, environmental and drug allergies, emergency contact information, immunization history, etc.
c. On-Line Health Coach Programs (OHC)—a series of on-line programs to help educate the individual on a variety of topics. The OHC programs provide a series of informational materials for the individual; in order to complete a level of the program and to proceed to the next level, interactive quizzes on the disease/condition are presented. Each program has five levels that must be successfully completed in order to complete the program. Exemplary programs include exercise, nutrition, weight loss, smoking, stress, diabetes and heart disease.
d. Trackers—as often as they like, an individual can enter certain biometric and other results so that they can graph and track the results. These results can be printed and taken to a doctor's office so that the physician can see the most recent biometric results. Current trackers include glucose readings, cholesterol readings, Hbalc readings, weight, logging steps taken, and tobacco usage.
e. Email communication—the clinical case manager can communicate directly with the individual through the Member Portal 400 via an email link.
f. Miscellaneous—there are also other interactive tools available, such as exercise instructions including a 3-D computerized mannequin to demonstrate how to do the exercises correctly, a meal planner and corresponding shopping list that can be printed and taken to the grocery store, a medical encyclopedia, a restaurant guide that displays calories and fat content for various food items, etc.
g. Incentive Point tracking—points are assigned for various activities, including the completion of the HRA, completion of the PHR, enrollment in and completion of the OHC programs, and entering various tracker data. These points will accumulate and can may be used through the health management system 1000, in conjunction with employer groups, to provide monetary or gift awards to the individual.

Periodically, e.g., on a monthly basis, a list of Disease Flags may be sent (feed F11) to the Member Portal 400 from the Decision Support Tool 100. This list of Disease Flags may be used within the Member Portal 400 to customize the individual's dashboard and to push educational information to the individual for their specific chronic disease or condition (i.e., diabetes, asthma, COPD, heart failure, coronary artery disease, obesity, pregnancy, depression and tobacco cessation). This customization of the individual's dashboard may also accomplished based on responses to the HRA and PHR. However, the Disease Flags from the Decision Support Tool 100, which are based on the individual's claim history, may also sent to the Member Portal 400 in order to push educational materials to the person.

Periodically, e.g., twice daily, specific data in the Member Portal 400 may be exported (feed F12) to the Workflow Management Module 300. The exported data generates notes and reminders to the clinical case manager to provide additional information on the individual and may result in additional phone calls and outreach being made to the individual. Examples of member entered data generating notes and reminders in the Workflow Management Module 300 may include:
medical conditions such as asthma, congestive heart failure, cad, diabetes, heart attack, cancers, eating disorders, multiple sclerosis, high blood pressure and high cholesterol;
allergies;
high risk (as determined by the results of the HRA);
enrollment in and completion of any OHC program;
completion of the HRA;
a body mass index that would indicate obesity;
a wellness score (determined by the result of the HRA) of less than a certain trigger amount;
an individual's plans to cope better with stress, to lose weight, to lower blood pressure, to lower cholesterol, to be more physically active, to quit smoking, to reduce alcohol, or to reduce fat;
tobacco use indicators;
pregnancy indicator; and
history of asthma, bronchitis, cancer, depression, diabetes, or heart disease.

In addition, the note may contain a link from the Workflow Management Module 300 to the Member Portal 400 system. This link allows the clinical case manager to go directly from the Workflow Management Module 300 and the information on that individual to the Member Portal 400 system to a ‘landing page’. The ‘landing page’ displays the critical data for the specific individual, and displays the HRA overall score for the individual, the individual items where the individual scored high and low, and the development plan suggestions for improvements. In addition, the clinical case manager can also see the actual HRA responses, the PHR data, OHC programs and levels, the tracker data, and all email messages sent/received for that person.

The ‘landing page’ prevents the clinical case manager from having to use two separate sign-ons (one for the Workflow Management Module 300 and one for the Member Portal 400). Since the link on the note takes the clinical case manager directly into that specific individual's Member Portal 400 account, the clinical case manager is able to more quickly access the important information for the person while they are on the phone with that individual.

Periodically, e.g., weekly, data from the Health Risk Assessment (HRA), PHR, OHC programs and incentive point tracking may be extracted and loaded (feed F14) to the Wellness Database 50 for reporting and monitoring purposes. The data extracted for the Wellness Database 50 may include:
all responses to the HRA questions;
the OHC programs enrolled in, the current program level, and the date of program completion;
PHR data to include demographic information, gender, height, weight and medical conditions; and
incentive points earned, broken down by category.

Periodically, e.g., monthly, data from the Wellness Database 50 may be loaded to the Decision Support Tool 100 for more in-depth reporting and monitoring purposes. Within the Decision Support Tool 100, the Member Portal data can be incorporated with other types of data including claims history, eligibility information, lab results, survey results, predictive modeling risk results, etc. to provide member profiles for physicians, ROI reporting, employer group reporting, etc. The data extracted from the Decision Support Tool 100 may include:
most responses to the HRA questions;
the OHC programs enrolled in and date completed; and
incentive points earned, broken down by category.

### 24 Hour Nurse Call Line

A 24 hour nurse call line 500 may be provided as part of the health management system 1000 so that a live nurse may extend the clinical reach of the system 1000 around the clock by providing immediate access to a live clinician on the phone or on line. The health management system 1000 may capture these interventions and follow up on these teachable moments by integrating the 24 hour nurse call line 500 into the clinical workflow (feed F15) and reporting platform via automated notes, reminders and triggers with appropriate routing logic based on the UPID and case manager assignment. Critical information for follow up to either mode of contact that is incorporated into the member record includes preferred logistics for follow up contact, provider information, chief complaints, history, recommended follow ups, as well as actionable assessments of understanding, compliance with treatment plan and readiness to change.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A system for managing the health care of a population, comprising:
a predictive modeling module adapted to compute risk information of an individual and adapted to format the risk information to comport with the format of a health insurance claim; and
a workflow management module comprising an interface for receiving a health insurance claim, the workflow management module disposed in communication with the predictive modeling module to receive from the predictive modeling module the risk information in a standard claim field of the health insurance claim to provide an analytic claim.

2. The system according to claim 1, wherein the predictive modeling module is adapted to compute a disease level that indicates the risk of the individual contracting a specific disease, and wherein the predictive modeling module is adapted to provide the disease level to the work flow management module for inclusion in a standard claim field of the health insurance claim.

3. The system according to claim 1, wherein the predictive modeling module is adapted to compute a population risk score containing a numerical risk score that indicates whether the individual can benefit from clinical intervention, and wherein the predictive modeling module is adapted to provide the population risk score to the work flow management module for inclusion in a standard claim field of the health insurance claim.

4. The system according to claim 1, wherein the predictive modeling module is adapted to compute the risk information of an individual over a specified time period, and wherein the predictive modeling module is adapted to provide the specified time period to the work flow management module for inclusion in a standard claim field of the health insurance claim.

5. The system according to claim 1, wherein the predictive modeling module is adapted to compute a level of priority for the risk score, and wherein the predictive modeling module is adapted to provide the level of priority to the work flow management module for inclusion in a standard claim field of the health insurance claim.

6. The system according to claim 1, wherein the predictive modeling module is adapted to provide a disease flag that indicates the type of disease for which the individual is at risk, and wherein the predictive modeling module is adapted to provide the disease flag to the work flow management module for inclusion in a standard claim field of the health insurance claim.

7. The system according to claim 1, wherein the predictive modeling module is adapted to compute a likelihood of hospitalization score that indicates the probability that the individual will require hospitalization, and wherein the predictive modeling module is adapted to provide the likelihood of hospitalization score to the work flow management module for inclusion in a standard claim field of the health insurance claim.

8. The system according to claim 1, wherein the predictive modeling module is adapted to record the date that the risk information was computed, and wherein the predictive modeling module is adapted to provide the date to the work flow management module for inclusion in a standard claim field of the health insurance claim.

9. The system according to claim 1, wherein the risk information comprises a numerical score indicating probability of illness based on analysis of pharmacy data of the individual.

10. A system for managing the health care of a population, comprising:
a workflow management module comprising an interface for receiving a note containing information about an individual; and
a predictive modeling module adapted to create a summary report comprising risk information of the individual and adapted to format the risk information to comport with a note format of the workflow management module, the predictive modeling module disposed in communication with the workflow management module to transmit the risk information to the note of the workflow management module.

11. The system according to claim 10, wherein the predictive modeling module is adapted to create a summary report comprising risk information that includes a population risk score that indicates whether the individual can benefit from clinical intervention, and is adapted to transmit the population risk score to the note of the workflow management module.

12. The system according to claim 10, wherein the predictive modeling module is adapted to create a summary report comprising risk information that includes a likelihood of hospitalization risk score and is adapted to transmit the likelihood of hospitalization risk score to the note of the workflow management module.

13. The system according to claim 10, wherein the predictive modeling module is adapted to create a summary report comprising risk information that includes a pharmacy risk score indicating probability of illness based on analysis of pharmacy data of the individual and is adapted to transmit the pharmacy risk score to the note of the workflow management module.

14. The system according to claim 10, wherein the predictive modeling module is adapted to create a summary report comprising a disease level that indicates the risk of the individual contracting a specific disease and is adapted to transmit the disease level to the note of the workflow management module.

15. A system for managing the health of a population, comprising:
a predictive modeling module adapted to compute a risk level of an individual and adapted to generate a reminder when the risk level increases relative to a previously computed risk level; and
a workflow management module disposed in communication with the predictive modeling module, the workflow management module comprising an interface for receiving the reminder from the predictive modeling module.

16. A method for managing the health care of a population, comprising:
providing a workflow management module comprising an interface for receiving a health insurance claim;
computing risk information of an individual;
formatting the risk information to comport with the format of the health insurance claim; and
providing the formatted risk information to the workflow management module in a claim field of the health insurance claim.

17. The method according to claim 16, wherein computing the risk information comprises computing a disease level that indicates the risk of the individual contracting a specific disease, and comprising providing the disease level to the work flow management module in a claim field of the health insurance claim.

18. The method according to claim 16, wherein computing the risk information comprises computing a population risk score containing a numerical risk score that indicates whether the individual can benefit from clinical intervention, and comprising providing the population risk score to the work flow management module in a claim field of the health insurance claim.

19. The method according to claim 16, wherein computing the risk information comprises computing the risk information of an individual over a specified time period, and comprising providing the specified time period to the work flow management module in a claim field of the health insurance claim.

20. The method according to claim 16, wherein computing the risk information comprises computing a level of priority for the risk score, and comprising providing the level of priority to the work flow management module in a claim field of the health insurance claim.

21. The method according to claim 16, comprising providing a disease flag that indicates the type of disease for which the individual is at risk, and providing the disease flag to the work flow management module in a claim field of the health insurance claim.

22. The method according to claim 16, wherein computing the risk information comprises computing a likelihood of hospitalization score that indicates the probability that the individual will require hospitalization, and comprising providing the likelihood of hospitalization score to the work flow management module in a claim field of the health insurance claim.

23. The method according to claim 16, comprising recording the date that the risk information was computed, and providing the date to the work flow management module for inclusion in a claim field of the health insurance claim.

24. The method according to claim 16, wherein computing the risk information comprises computing a numerical score indicating probability of illness based on analysis of pharmacy data of the individual.

25. A method for managing the health care of a population, comprising:
providing a workflow management module having an interface for receiving a note containing information about an individual;
creating a summary report comprising risk information of the individual;
formatting the risk information to comport with a note format of the workflow management module; and
transmitting the risk information to the note of the workflow management module.

26. The method according to claim 25, wherein the risk information includes a population risk score containing a numerical risk score that indicates whether the individual can benefit from clinical intervention, and comprising transmitting the population risk score to the note of the workflow management module.

27. The method according to claim 25, wherein the risk information includes a likelihood of hospitalization risk score, and comprising transmitting the likelihood of hospitalization risk score to the note of the workflow management module.

28. The method according to claim 25, wherein the risk information includes a pharmacy risk score indicating a probability of illness based on analysis of pharmacy data of the individual, and comprising transmitting the pharmacy risk score to the note of the workflow management module.

29. The method according to claim 25, wherein the risk information includes a disease level that indicates the risk of the individual contracting a specific disease, and comprising transmitting the disease level to the note of the workflow management module.

30. A method for managing the health of a population, comprising:
providing a workflow management module comprising an interface for receiving a reminder;
computing a risk level of an individual;
generating a reminder when the risk level increases relative to a previously computed risk level; and
providing the reminder to the workflow management module.
